(19) United States
(12) Patent Application Publication
(10) Pub. No.: US 2011/0116094 A1
(43) Pub. Date: May 19, 2011

(54) Method of Producing a Surface Plasmon Generator, a Surface Plasmon Generator and a Sensor Incorporating the Surface Plasmon Generator

(75) Inventors: Thomas David Paul Allsop, Birmingham (GB); Ian Bennion, Northamptonshire (GB); David John Webb, Shropshire (GB); Ronald Neal, Cornwall (GB)

(73) Assignee: ASTON UNIVERSITY, Birmingham (GB)

(21) Appl. No.: 12/743,036

(22) PCT Filed: Nov. 4, 2008
(86) PCT No.: PCT/GB08/03715

§ 371 Date: May 14, 2010

(30) Foreign Application Priority Data
Nov. 15, 2007 (GB) 0722480.1

(51) Int. Cl. G01N 21/55; G02F 1/295; G02B 1/12

(52) U.S. Cl. 356/445; 385/4; 264/1.27

(57) ABSTRACT

Surface plasmon generation on a metal or semiconductor layer at an outer surface of an optical waveguide, using light reflected or scattered from inside the optical waveguide. One aspect provides a main optical waveguide (11) (e.g. optical fibre) having a second optical waveguide (18) adhered thereto, the second optical waveguide including an optically transparent material (610) separating two surface plasmon supporting layers (600, 620). Another aspect provides a surface plasmon supporting layer of material(s) adhered to the main optical waveguide, the layer having photo-induced regions of material compaction. The regions of compaction may cause un-inscribed refractive index modulations in the main optical waveguide. The surface plasmons are coupled to the guided mode(s) in the main optical waveguide. Surface plasmon resonance depends on sample material in contact with an outermost surface plasmon supporting layer. Properties of the sample material can thus be detected in output guided mode(s) because of the coupling with the generated surface plasmons.

### FIELD OF THE INVENTION

The present invention relates to the generation of surface plasmons, and particularly, though not exclusively, to sensing methods and apparatus using surface plasmons.

### BACKGROUND TO THE INVENTION

Free electrons of a metal can be treated as an electron liquid of high density. At the surface of a metal or semiconductor, longitudinal electron density fluctuations, or plasma oscillations, may occur and will propagate along the surface.

These coherent fluctuations are accompanied by an electromagnetic field comprising a component transverse to (i.e. away from) the surface, and a component(s) parallel to the surface. The transverse electromagnetic field falls rapidly with increasing distance from the metal or semiconductor surface, having its maximum at the surface, and is sensitive to the properties of the metal or semiconductor surface and the properties of the dielectric substance (e.g. air, aqueous solution) immediately at and above the surface and into which the transverse electric field component extends.

This propagating free electron surface charge fluctuation, and its attendant electromagnetic field, is a surface plasmon.

A surface plasmon can propagate along a metallic or semiconductor surface with a broad spectrum of eigenfrequencies from ω32 0 up to a maximum value depending upon its wave vector k. The dispersion relation ω(k) of a surface plasmon, which relates the eigenfrequency to the wave vector, shows that surface plasmons have a longer wave vector than light of the same energy propagating along the surface. Surface plasmons are, as a consequence, non-radiative and are characterised as surface waves having an electromagnetic field which decays exponentially with increasing distance from, and transverse to, the surface upon which they propagate. Due to the differing dispersion relations of photons (in air) and surface plasmons, and the non-radiative nature of surface plasmons, photons in air cannot couple to surface plasmons. This is schematically illustrated in FIG. 1 which shows the dispersion relation of photons (in air) and surface plasmons graphically. The dispersion curve of the photon (in air) never crosses the dispersion curve of the surface plasmon. Consequently, the two cannot couple or “transform” between each other due to being unable to satisfy the requirements of both energy and momentum conservation during “transformation”.

Excitation of surface plasmons is not possible using photons (in air) unless a means is used to transfer additional momentum (Δkₓ) to the photon such that, for a given photon frequency, the photon momentum is equal to the momentum permitted for a surface plasmon at the same frequency.

One means of achieving this is to form the metal or semiconductor surface 2 upon a diffraction grating surface 1 (e.g. by forming corrugations in the surface). When light 3 strikes the metal or semiconductor grating surface, having a grating constant a, at an angle θ, the component (kₓ) of the wave vector of the light along the surface becomes:

$${k}_{x} = \frac{ω}{c} sin ( θ ) \pm \frac{2 π n}{a} ,$$

where n is an integer and c is the speed of light in a vacuum. Thus, the metal or semiconductor surface grating may impart the extra momentum

$$( Δ {k}_{x} = \frac{2 π n}{a} )$$

needed by the photon to enable it to reach the surface plasmon dispersion curve to “transform” into (i.e. excite) a surface plasmon. FIG. 2 graphically illustrates this.

The reflected light intensity attenuates when excitation of surface plasmons is greatest and photons “transform” into surface plasmons resonantly.

Another means for photon-plasmon coupling is the use of “attenuated total reflection” (ATR) such as exemplified by the so-called Kretschmann-Raether prism arrangement schematically illustrated in FIG. 3. Light 3 is directed towards an interface with a metal or semiconductor surface 2 using a prism 4 made of a material having a refractive index nₚ (e.g. quartz), at which it is totally reflected. The dispersion relation of photons in the prism, and reaching the interface, is

$$ω = \frac{ck}{{n}_{p} .}$$

Thus, the extra momentum (Δkₓ) required by the photon to couple to surface plasmons arises from the optical properties of the coupling prism 5. Photons may excite plasmons when the component (kₓ) of the wave vector of the reflected light (in-prism) matches that permitted by surface plasmons of the same frequency, i.e.:

$${k}_{x} = {n}_{p} \frac{ω}{c} sin ( θ ) = {k}_{sp} ,$$

where θ is the angle of incidence at which light is totally reflected. FIG. 3 graphically illustrates this. This resonant “transformation” of photons into surface plasmons results in an attenuation of the totally reflected light exiting the prism, hence the appellation “attenuated total reflection”.

Thus, both means of resonantly coupling photons to surface plasmons (grating surfaces, ATR etc) result in “surface plasmon resonances” (SPR) indicated by a resonant drop in reflected light from the plasmon-bearing metal or semiconductor interface. Since the surface plasmon propagates at the outwardly presented surface of the metal or semiconductor in question, the optical properties of the dielectric material (e.g. air, aqueous solution etc) to which the metal or semiconductor surface is outwardly presented (e.g. exposed), become highly influential upon the nature and degree of the resonant attenuation of reflected light used to resonantly excite the surface plasmons. This fact is exploited in sensor devices which measure properties of dielectric sample substances using surface plasmons generated as discussed above.

If the relative dielectric constants of the metal or semiconductor surface and the dielectric material at the outwardly presented (e.g. exposed) surface of the metal or semiconductor, are εₘ and ε_{d} respectively, then the wave vector kₛₚ of a surface plasmon propagating at the outwardly presented (e.g. exposed) metal or semiconductor surface, and extending transversely thereto into the dielectric material is:

$${k}_{sp} = \frac{ω}{c} {( \frac{{ɛ}_{m} {ɛ}_{d}}{{ɛ}_{m} + {ɛ}_{d}} )}^{1 / 2}$$

Thus, the value of ε_{d} determines the value of kₛₚ and thus the angle of incidence (θ) upon the plasmon-bearing surface at which a photon can resonantly excite surface plasmons. Thus, by monitoring the intensity of reflected light to determine the position of resonant attenuation of reflected light, one may determine a measure of ε_{d}. Changes in ε_{d} may also be monitored as changes in the angular position of the reflected light attenuation resonance. FIG. 4 schematically illustrates an example of two attenuation resonances occurring at different reflection angles (θ₁ and θ₂) each corresponding with the presence of a dielectric material of a different respective ε_{d} at the outwardly presented (e.g., exposed) metal or semiconductor plasmon-bearing surface.

The value of ε_{d} is intimately related to the properties (e.g. optical properties) of the dielectric substance which can, in this way, be sensed and probed using surface plasmons. For example, the value of the refractive index (n_{d}) of the dielectric is equal to the square root of its dielectric constant (n_{d}²=ε_{d}). However, these prior art surface plasmon generating arrangements, and sample sensing methodologies, either require plasmon-exciting light to first pass through the dielectric sample (ε_{d}) being sensed (e.g. surface grating arrangements), or require bulky and cumbersome prisms (the Kretschmann arrangement) which also suffer from in-prism reflected light losses due to reflection at prism surfaces. Both of the above techniques fundamentally rely upon monitoring changes in the intensity of reflected plasmon-exciting light and so suffer the detrimental consequences of irregularities or impurities at the light-reflecting (prism or grating) surface.

### SUMMARY OF THE INVENTION

The present invention aims to address at least some of the above deficiencies.

As its most general, the present invention proposes the generation of surface plasmons on a metal or semiconductor layer arranged upon an outer surface of an optical waveguide, using light from inside the optical waveguide. The plasmon-generating light may be a reflected or scattered part of guided light travelling along the optical waveguide.

In this way, the present invention may enable part of the guided light to form a radiative optical mode(s) which is used to excite surface plasmons and which is also coupled to the remaining guided mode(s) of the light from which it derives.

This coupling of the radiation mode(s) and the guided mode(s) enables changes in the radiation mode(s) to cause consequential changes in the guided mode(s) of light. Such changes in the radiation mode(s) may occur due to the coupling of the out-coupled mode(s) to the surface plasmons they excite at the metal or semiconductor layer. Thus, the greater the degree of coupling between the radiative optical mode(s) and the surface plasmons in question, the greater the consequential change in the remaining guided mode(s) to which the radiative mode(s) are coupled. In this way, the extent of surface plasmon generation is imprinted upon, or leaves a signature within, the properties of the remaining guided mode(s) of the light used to excite the surface plasmons.

Accordingly, in a first of its aspects, the invention may provide a surface plasmon generator including a first optical waveguide (e.g. silica) arranged to guide optical radiation input thereto, a second optical waveguide adhered to (e.g. bonded to, or formed upon) an outer surface of the first optical waveguide and optically coupled thereto wherein the second optical waveguide includes an optically transparent material (e.g. transparent at optical wavelengths, e.g. microns, such as silica) separating two layers each formed from a material arranged (e.g. a metal or semi-conductor, optionally different such materials) to support upon a respective surface thereof a surface plasmon generated by optical radiation input to the first optical waveguide. The transparent layer/material may be bonded or adhered to the two surface plasmon-supporting layers it separates.

In this way, optical radiation input to the first optical waveguide may be used to generate concurrent surface plasmons on the surfaces of the separate plasmon-supporting layers of the second optical waveguide. For example, the evanescent wave of optical radiation guided along the first optical waveguide may couple, or extend to, the second optical waveguide to enable surface plasmons to be generated there. Modulations of the refractive index of the material of the first optical waveguide may be provided in the guiding region thereof adjacent the second optical waveguide thereby to assist in transferring optical energy from the first optical waveguide to the second (e.g. by reflection, scattering or interference processes such as cavity-type resonances between successive refractive index modulations). These refractive index modulation may be directly optically inscribed into the guiding region of the first optical waveguide (e.g. in the form of a grating structure, such as a Bragg grating (reflective) or a long-period grating (transmissive) or the like) using known optical inscription techniques (e.g. direct pulsed laser writing or by holographic or phase-mask processes).

However, it has been found that photo-inducing changes in the material of the second optical waveguide by application of Ultraviolet (UV) radiation to it may result in compaction of the irradiated materials of the second optical waveguide. These regions of compaction are believed to generate strain within the material of the second optical waveguide, which extends into the guiding region of the first optical waveguide across the interface where the second optical waveguide is adhered to the first optical waveguide. This extended strain field is believed to be the cause of observed strain-induced (but not inscribed) modulations in the value of the refractive index of the material of the first optical waveguide subject to the strain field.

Accordingly, the second optical waveguide may contain photo-induced regions of material compaction therein. These regions of compaction may be in a surface plasmon-supporting layer such as the one nearmost the first optical waveguide. When that nearmost layer is germanium, and the first optical waveguide is silica, it is believed that GeO₂ is formed at the interface between germanium and silica, for example the interface between the first optical waveguide and the second optical waveguide, due to the reactive nature of germanium. Irradiation of the germanium layer with ultraviolet radiation induces increased such reactions in proportion to the intensity of the ultraviolet radiation in question. Spatial variation (e.g. periodic) in UV intensity cause spatial variation in reaction extent. This results in varying strain/compaction at reacted regions thereby producing a spatially varying strain field associated with it. Consequently, the first optical waveguide may contain strain-induced refractive index modulations therein resulting from the regions of material compaction. These modulations may assist in coupling guided optical radiation from within the first optical waveguide to the second for surface plasmon generation there. They may render the second optical waveguide in optical communication with the refractive index modulation(s) by scattering of optical radiation input to the first optical waveguide.

Preferably, the regions of surface compaction are arranged in the second optical waveguide in a periodic or quasi-periodic array e.g. along a direction parallel to the transmission axis of the first optical waveguide. The resulting strain field, and strain-induced refractive index modulation within the first optical waveguide may thus extend across, and vary along, the transmission axis of the first optical waveguide. The first optical waveguide may thus include one or more un-inscribed refractive index modulations in regions of the first optical waveguide adjacent the second optical waveguide. One or more of the un-inscribed refractive index modulations may extend in a direction transverse to an optical transmission axis of the first optical waveguide.

The UV irradiation may be sufficient to inscribe a surface-relief structure on the outermost surface of the second optical waveguide. The second optical waveguide may have an undulating surface relief profile photo-induced on an outermost surface thereof. This may assist in generating surface plasmons at that outermost surface and/or in spatially localising the surface plasmons. In particular, such a surface relied structure assists in coupling guided light in first optical waveguide to surface plasmon modes.

Most preferably the surface relief structure does not extend into the first optical waveguide.

The first optical waveguide may be an optical fibre. The second optical waveguide may be a planar optical waveguide, such as a stack of layers comprising an optically transparent layer sandwiched between metallic or semi-conducting layers.

Preferably the separation between the two layers of the surface plasmon-supporting material of the second optical waveguide is substantially uniform and constant along the second optical waveguide. The thickness of the optically transparent material separating the two layers of plasmon-supporting material may preferably be substantially uniform such as a uniform layer (e.g. silica).

Preferably, the value of this thickness, or the value of the separation discussed above, is of the order of the value of the operating wavelength of optical radiation with which the surface plasmon generator is operated or arranged to generate surface plasmon (e.g. at or around 1500 nm). For example, the value of the thickness or separation may differ from the value of the operating wavelength by no more than 50%, or 40%, or 30%, or 20%, or 10%, or 5% thereof. This arrangement has been found to have the beneficial effect of allowing concurrently generated surface plasmons on opposite surface plasmon-supporting layers of the second optical waveguide, to couple together or “cross-talk” such that the surface plasmon nearmost the first optical waveguide, and the surface plasmon generating radiation within it, may positively reinforce or support the surface plasmon furthest from the first optical waveguide. The second optical waveguide acts to guide an enhanced surface plasmon mode in this way. Furthermore, the result of such an enhanced surface plasmon mode is to reduce the effective refractive index “seen” by the enhanced surface plasmon mode at the second optical waveguide as compared to the effective refractive index in the absence of the second optical waveguide. Consequently, the difference between the lower effective refractive index and the refractive index of a sample at the outermost surface of the second optical waveguide is also lower. As a result, the field of the enhanced surface plasmon may extend further into the sensed sample than would otherwise be the case, thereby enhancing the sensitivity of the surface plasmon generator when used as a sensor, and/or enabling it to sense samples with lower refractive indices (e.g. gases or vapours etc).

The first optical waveguide may have a core part and cladding part adjacent the core part, and one or more un-inscribed refractive index modulations may extend across at least a part of the core part of the optical waveguide.

The first optical waveguide may have a core part and a cladding part adjacent to the core part which is lapped to define a proximal outer surface area being closer to the core part than are other adjacent outer surface areas of the cladding part. The second optical waveguide may be formed upon the proximal outer surface area. The proximal outer surface area may be substantially flat.

At least parts of the outermost surface of the second optical waveguide may include a covering of metal, such as silver, or gold. The second optical waveguide may include a layer of optically transparent material, such as silica, upon which the covering of metal is formed. The covering of metal may comprise a plurality of spatially separated metal regions. The metal regions may be the same or different metals. This arrangement may take advantage of the short propagation distance of the surface plasmon to provide a device sensitive to a plurality of responses, e.g. at different wavelengths, to improve overall resolution.

The first optical waveguide may be a clad single mode optical waveguide (e.g. silica) constructed and arranged to support single mode transmission of optical radiation of wavelengths above 1000 nm.

The first optical waveguide may have an input part which is an end of the first optical waveguide for receiving optical radiation into the first optical waveguide.

The first optical waveguide may include an output part comprising an end of the first optical waveguide for receiving optical radiation having passed from the input part through the first optical waveguide (e.g. through refractive index modulation(s) therein).

In a second of its aspects, the present invention may provide a surface plasmon generator including an optical waveguide (e.g. silica) arranged to guide optical radiation input thereto, a layer of material(s) adhered to an outer surface of the optical waveguide and optically coupled thereto wherein the layer has photo-induced regions of material compaction therein and is arranged to support upon a surface thereof a surface plasmon generated by optical radiation input to the optical waveguide. Photo-induction may be achieved, and have the consequences, as discussed above.

The optical waveguide may be an optical fibre.

One or more of the un-inscribed refractive index modulations may extend in a direction transverse to an optical transmission axis of the optical waveguide.

The optical waveguide may have a core part and cladding part adjacent the core part, and one or more un-inscribed refractive index modulations may extend across at least a part of the core part of the optical waveguide.

The layer of material(s) may have an undulating surface relief profile photo-induced on an outermost surface thereof. The consequences and benefits of this are discussed above. Preferably, the surface relief does not extend into the optical waveguide. The profile may assist in generating surface plasmons at that outermost surface and/or in spatially localising the surface plasmons. In particular, such a surface relied structure assists in coupling guided light in first optical waveguide to surface plasmon modes.

The surface plasmon generator may include a second optical waveguide which includes the layer of material(s) and which is optically coupled to the first the optical waveguide wherein the second optical waveguide includes an optically transparent material separating the layer from another layer formed from a material arranged to support upon a surface thereof a surface plasmon generated by optical radiation input to the first the optical waveguide. The second optical waveguide may be a planar optical waveguide.

The optical waveguide may include one or more un-inscribed refractive index modulations in regions of the optical waveguide adjacent the layer of material(s).

The optical waveguide may have a core part and a cladding part adjacent to the core part which is lapped to define a proximal outer surface area being closer to the core part than are other adjacent outer surface areas of the cladding part. The layer of material(s) is preferably formed upon the proximal outer surface area.

The proximal outer surface area may be substantially flat.

At least parts of the outermost surface of the layer of material(s) may include a covering of metal (e.g. gold or silver). The layer of material(s) may include a layer of optically transparent material (e.g. silica) upon which the covering of metal is formed.

The optical waveguide may be a clad single mode optical waveguide (e.g. silica) constructed and arranged to support single mode transmission of optical radiation of wavelengths above 1000 nm.

The optical waveguide may have an input part which is an end of the optical waveguide for receiving optical radiation into the optical waveguide.

The optical waveguide may include an output part comprising an end of the optical waveguide for receiving optical radiation having passed from the input part through the optical waveguide (e.g. through refractive index modulation(s) therein).

In any of its first and second aspects, the waveguide (or first optical waveguide) may be silica. The layer of material or materials (second aspect) or any of the two layers of material (first aspect) may be selected from: germanium, gold, silver, platinum, copper, palladium, aluminium, a vanadium oxide or vanadium oxides. The outermost metal covering of the surface plasmon generator may be a metal selected from any of the above. Other materials may be selected. Preferably the material(s) which forms the layer of material(s) or which forms a layer in the second optical waveguide, is/are chosen such that the optical skin depth of the material in question, at the operating optical wavelength of the surface plasmon generator, is greater than the thickness of the layer in question. Where there are several layers of material(s), e.g. e.g. forming a stack of layers of materials, such as the second optical waveguide as a whole, preferably the sum of the optical skin depths of each component layer of material exceeds the depth/height of the stack. The material(s) may be selected such that skin depth in question is from 5 microns to 100 microns in extent, or from 5 microns to 75 microns, or from 5 microns to 50 microns in extent, or from 5 microns to and 30 microns in extent. The operating optical wavelength of the surface plasmon generator may be between 1 micron and 10 microns, or between 1 micron and 5 microns, or between 1 micron and 2 microns, or between 1.5 and 1.7 microns.

The skin depth S of a material layer of complex refractive index n, in respect of electromagnetic radiation of wavelength λ may be defined as:

$$S = \frac{λ}{4 π Im ( n )}$$

The benefit of employing materials supporting a relatively large skin depth is to enhance penetration of guided electromagnetic energy to the surfaces arranged to support surface plasmons in the surface plasmon generator.

The optical waveguide may be maintained in an un-flexed state, at least in the proximity of the layer or second optical waveguide thereby reducing the space required by the surface plasmon generator, reducing stresses. The optical waveguide may possess optical waveguide cladding but is preferably otherwise not itself embedded, or encased in any holding substrate of material (such as epoxy), thus, the outer circumferential surface/length of the optical waveguide may be exposed.

The optical waveguide may have a core part and a cladding part adjacent to the core part which is lapped to define a proximal outer surface area being closer to the core part than are other adjacent outer surface areas of the cladding part. The proximal outer surface area may, but preferably does not, expose a part of the waveguide core. The lapped cladding part enables not only the formation of a flat interface and outwardly presented (e.g. exposed) outer layer of material(s) or second optical waveguide surface, but also enables greater proximity of the interface between the layer of material(s), or second optical waveguide, to the core part of the optical waveguide from which surface plasmon inducing radiative modes derive. The lapped region of the waveguide may be such as to present a D-shaped cross-sectional profile if viewed in a direction along the waveguide (e.g. fibre) axis, the proximal outer surface area defining the flat part of the D. The thickness of cladding at the lapped cladding part is preferably between about 15 μm and 5 μm, though other optimal thicknesses may be employed.

The proximal outer surface area may be substantially flat, and may be generally parallel to the axis of the waveguide core part, at least at the location of refractive index modulation(s) in the core of the lapped optical fibre, and may be arranged to substantially extend over, or overlap, the refractive index modulation(s) when the outer surface area is viewed face-on.

An outermost metal layer or covering on parts of the second optical waveguide, or the layer of material(s), may be between 10 nm and 60 nm in thickness, and may preferably be between 30 nm and 50 nm in thickness, preferably being about 50 nm in thickness.

In a third of its aspects, the invention may provide a sensor including a surface plasmon generator according to the invention in its first aspect, an optical radiation source in optical communication with an optical input part of the surface plasmon generator, and an optical radiation detector arranged to detect optical radiation having passed through the surface plasmon generator from the input part, wherein the second optical waveguide defines a sensing area for receiving a sample to be sensed using surface plasmons.

In a fourth of its aspects, the invention may provide a sensor including a surface plasmon generator according to the invention in its second aspect, an optical radiation source in optical communication with an optical input part of the surface plasmon generator, and an optical radiation detector arranged to detect optical radiation having passed through the surface plasmon generator from the input part, wherein the layer of material(s) defines a sensing area for receiving a sample to be sensed using surface plasmons.

The optical radiation detector may be an optical spectrum analyser responsive to optical radiation generated by the optical radiation source.

The sensor may include a polarisation control means in optical communication with the optical radiation source and the input part of the surface plasmon generator, arranged for controlling the state of polarisation of optical radiation from the optical radiation source for input to the surface plasmon generator.

The optical radiation source may be operable to generate Infra-Red (IR) optical radiation. The optical radiation source may be arranged to generate broadband optical radiation comprising a range of optical wavelengths.

In a fifth of its aspects, the invention may provide a sample analyser for analysing a sample of a substance using surface plasmon resonances including a sensor according to the invention in any of its third or fourth aspects.

The sample analyser may include a signal processor means arranged to identify resonances in the spectrum of an optical radiation received thereby from the optical radiation source via the surface plasmon generator.

The signal processor means may be arranged to determine one or more of the position, the depth, the width of an identified the resonance.

The sample analyser may include a sample control means for placing the sample in contact with the sensing area of the surface plasmon generator.

The optical signal detector may be an optical spectrum analyser responsive to optical radiation generated by the optical signal source. The optical signal source may be operable to generate Infra-Red (IR) optical signals (e.g. only IR signals) and may be arranged to generate broadband optical signals comprising a range of optical wavelengths, e.g. all within the IR spectrum, such as only within the range 1000 nm to 2000 nm, or such as only the range 1100 nm to 1700 nm.

It has been found that the degree of surface plasmon generation and/or the sensitivity of the sensor of the invention is dependent upon the state of polarisation of the guided optical signal modes input to the optical waveguide. The polarisation control means, being of a type and structure such as would be readily apparent to the skilled person, may be employed to tune the sensor's sensitivity accordingly.

As has been discussed above, the degree of surface plasmon excitation, and the wavelength of optical signal used to resonantly excite surface plasmons, is detectable in the spectrum of the guided modes of the optical signal output by surface plasmon generator, as an output signal intensity attenuation resonance.

These and/or other properties of the spectrum may be monitored or measured in analysing the sample substance in question. The signal processor means may include a computer means suitably programmed to effect such monitoring and/or measurement. Changes over a period of time, in any of the aforesaid properties, may be so monitored and/or measured and correlated to dynamic (or otherwise) properties of the sample in question. The signal processor means may be arranged to determine the refractive index of a sample substance according to the spectral position (e.g. signal wavelength) and/or strength, depth or amplitude of identified output signal intensity attenuation resonance, and may be arranged to determine a change in the refractive index according to a change in the spectral position.

It is to be understood that the apparatus and arrangements described above in any one or more the aspects of the invention may each realise a corresponding method of surface plasmon generation, of sensing using surface plasmons, and of sample analysis using surface plasmons. These corresponding methods are encompassed by the invention.

In a sixth of its aspects, the invention may provide a method for generating a surface plasmon including: providing a surface plasmon generator according to the invention in its first aspect; directing optical radiation into the surface plasmon generator via an optical input part thereof; coupling a part of the input optical radiation at the first optical waveguide towards the second optical waveguide; generating a surface plasmon at a surface of each of the two the separated layers of the second optical waveguide using the coupled part of the input optical radiation.

In a seventh of its aspects, the invention may provide a method of sensing including generating a surface plasmon according to the invention in its sixth aspect with a sample substance placed in contact with an outwardly presented metal surface of the plasmon generator, transmitting a part of the input optical radiation through the first optical waveguide and detecting the intensity of the transmitted part of the input optical radiation thereby to sense the sample substance using the surface plasmon.

In an eighth of its aspects, the invention may provide a method for generating a surface plasmon including: providing a surface plasmon generator according to the invention in its second aspect; directing optical radiation into the surface plasmon generator via an optical input part thereof; coupling a part of the input optical radiation at the optical waveguide towards the layer of material(s); generating a surface plasmon at a surface of the plasmon generator using the coupled part of the input optical radiation.

In a ninth of its aspects the invention may provide a method of sensing including generating a surface plasmon according to the invention in its eighth aspect with a sample substance placed in contact with an outwardly presented metal surface of the plasmon generator, transmitting a part of the input optical radiation through the optical waveguide and detecting the intensity of the transmitted part of the input optical radiation thereby to sense the sample substance using the surface plasmon.

The method may include detecting a minimum in the radiation intensity in the optical spectrum of the transmitted part of the input optical radiation.

In a tenth of its aspects, the invention may provide a method of sample analysis including the method of sensing according to the invention in any of its seventh or ninth aspects including measuring changes in a property of the transmitted part of the input optical radiation in dependence upon changes in a property of the sample being sensed.

The sensor, or a sample analyser described above may be arranged to sense or analyse a sample having a refractive index having a value between 1.0 and 1.3, such as a gas or vapour.

In another of its aspects, the invention may provide a method of producing a surface plasmon generator including providing a first optical waveguide, providing a second optical waveguide optically coupled and adhered to an outer surface of the first optical waveguide and including an optically transparent material separating two layers each formed from a material arranged to support upon a respective surface thereof a surface plasmon generated by optical radiation input to the first optical waveguide.

The method may include successively depositing a first of the two layers, the optically transparent material, and a second of the two layers to form upon the first optical waveguide a stack of materials defining the second optical waveguide.

The method may include successively depositing on the second optical waveguide a further optically transparent material, and a layer of metal on the further optically transparent material thereby to extend the stack.

The method may include irradiating the outermost surface of the second optical waveguide with optical radiation to inscribe upon the surface an undulating surface relief profile, one or more regions of material compaction within the material of the second optical waveguide and a corresponding strain field extending into the first optical waveguide.

In yet another of its aspects, the invention may provide a method of producing a surface plasmon generator including providing an optical waveguide, providing a layer of material(s) optically coupled and adhered to an outer surface of the optical waveguide, photo-inducing one or more regions of material compaction within the layer of material(s) wherein the layer is arranged to support upon a surface thereof a surface plasmon generated by optical radiation input to the optical waveguide.

This method may include depositing the layer on the optical waveguide. The method may include successively depositing a layer of metal on the outermost surface of the layer of material(s) to extend the layer of material(s).

The method may also include irradiating the outermost surface of the layer of material(s) with optical radiation to inscribe upon the surface an undulating surface relief profile, one or more regions of material compaction within the material(s) of the layer and a corresponding strain field extending into the optical waveguide.

### BRIEF DESCRIPTION OF THE DRAWINGS

There now follow examples of the invention, with reference to the accompanying drawings, as non-limiting embodiments useful for understanding the invention at its most general. In the drawings:

FIG. 1 schematically illustrates the dispersion relations of a photon in air a surface plasmon and is discussed above;

FIG. 2 schematically illustrates a surface grating coupler for generating surface plasmons, together with a graphical dispersion relation illustrating the resonant excitation of a surface plasmon using a photon in air coupled to the surface plasmon via the grating and is discussed above;

FIG. 3 schematically illustrates a Kretschmann-Raether prism coupler for generating surface plasmons, together with a graphical dispersion relation illustrating the resonant excitation of a surface plasmon using photons in the prism coupled to the surface plasmon and is discussed above;

FIG. 4 schematically illustrates optical signal attenuation resonances in the spectrum of light reflected from a coupler of FIG. 2 or FIG. 3 in exciting surface plasmons and is discussed above;

FIG. 5 schematically illustrates a cross-sectional view of a surface plasmon generator that is an embodiment of the invention;

FIG. 6 schematically illustrates a sensor employing a surface plasmon generator that is another embodiment of the invention;

FIG. 7A illustrates an atomic force microscope image of a surface relief structure, FIG. 7B illustrates a line profile across the surface thereof, and FIG. 7C a Fourier transform of the line profile;

FIG. 8 graphically illustrates transmission spectra of a surface plasmon sensor of FIG. 6 according to two different states of linear polarisation input optical radiation;

FIGS. 9A and 9B graphically illustrate spectral characteristics of a surface plasmon sensor device;

FIGS. 10A and 10B graphically illustrates transmission spectra of two surface plasmon sensor devices having differing thicknesses of a first layer of germanium in a multi-layer stack;

FIGS. 11A and 11B graphically illustrate spectral behaviour of surface plasmon detectors having different thicknesses of a first layer of germanium in a multi-layer stack;

FIGS. 12A and 12B graphically illustrate a comparison between measured spectral characteristics (solid lines) of a surface plasmon sensor device, possessing a multi-layer stack, and theoretical results (dotted lines) in respect of a surface plasmon device having a single-layer coating;

FIG. 13 schematically illustrates a sensor employing a surface plasmon generator according to an example of the invention;

FIG. 14 graphically illustrates the reflection spectrum of the surface plasmon generator in air and in respect of linearly polarised input light;

FIG. 15 graphically illustrates an expanded view of part of FIG. 14;

FIG. 16A graphically illustrates the transmission spectrum of the surface plasmon generator with which FIG. 14 is concerned but in respect of a lower input optical signal intensity, and FIG. 16B graphically illustrates the reflection spectrum thereof;

FIG. 17 graphically illustrates a reflection spectrum and a transmission spectrum of the surface plasmon generator with which FIG. 16 is concerned, but in respect of a different state of linear polarisation of input optical radiation;

FIGS. 18A and 18B graphically illustrate a reflection spectrum and a transmission spectrum of the surface plasmon generator with which FIGS. 16 and 17 are concerned, but in respect of a different state of linear polarisation of input optical radiation;

FIGS. 19A and 19B graphically illustrate a reflection spectrum and a transmission spectrum of the surface plasmon generator with which FIGS. 16, 17 and 18 are concerned, but in respect of a different state of linear polarisation of input optical radiation;

FIG. 20 graphically illustrates a reflection spectra of the surface plasmon generator with which FIGS. 16 to 19 are concerned, and in respect of two different states of linear polarisation of input optical radiation;

FIG. 21 graphically illustrates a variation of maximum coupling strength of the plasmon in an experiment where the surface plasmon generator was exposed to ethanol vapour that was gradually heated;

FIG. 22 graphically illustrates a variation of maximum coupling wavelength of the plasmon for the same experiment as FIG. 21;

FIG. 23 graphically illustrates a variation of maximum coupling strength of the plasmon using a centroid value for the same experiment as FIG. 21; and

FIG. 24 graphically illustrates a variation of maximum coupling wavelength of the plasmon using a centroid value for the same experiment as FIG. 21.

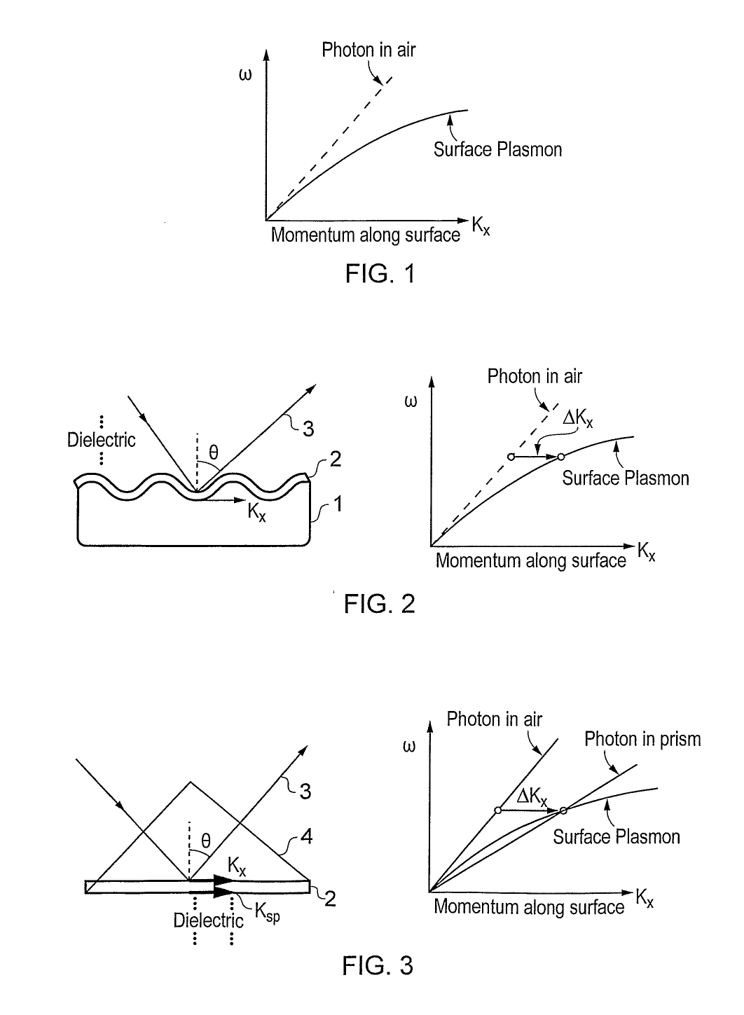

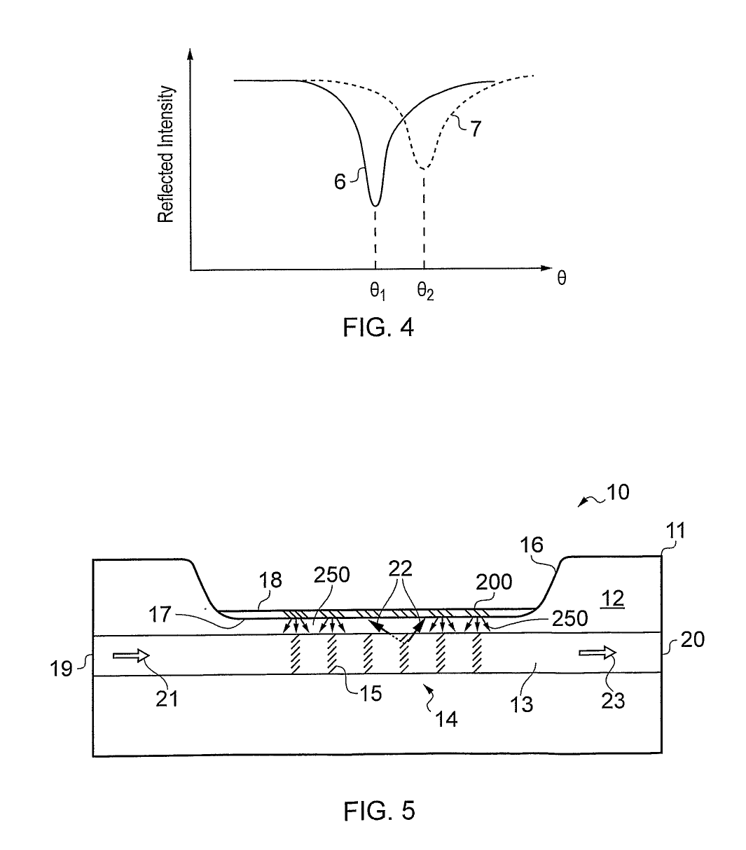

### DETAILED DESCRIPTION; FURTHER OPTIONS AND PREFERENCES

### System Overview

Referring to FIG. 5 there is schematically illustrated, in cross section, an example of a surface plasmon generator 10 according to an example of the present invention.

The surface plasmon generator includes a length of optical fibre 11 having an optical signal input part 19 comprising an open end of the optical fibre length arranged for receiving optical signals into the optical fibre, and an optical output part 20 comprising an open end of the optical fibre from which output optical signals can be received from the optical fibre.

The optical fibre has an optical fibre core part 13 clad by an optical fibre cladding 12. The diameter of the core part, and the dimensions, structure and design of the optical fibre as a whole, are such as to render the optical fibre a single-mode optical fibre in respect of optical signals having a wavelength in excess of about 1000 nanometres (as measured in vacuum).

The cladding part of the optical fibre is lapped 16 to define a proximal outer surface area 17 which is closer to the core part 13 than are other adjacent outer surface areas (un-lapped) of the cladding part 12. The proximal outer surface area 17 formed by lapping the cladding part defines a substantially flat outer surface area of the cladding part nearmost, but not exposing, a length of the underlying core part 13 of the optical fibre. The substantially flat proximal outer surface area is in a plane generally parallel to the axis of the optical fibre such that points upon the proximal outer surface forming a line parallel to the longitudinal (i.e. transmission) axis of the optical fibre are each equally spaced from the optical fibre core part 13.

A multi-layer stack 18 is deposited upon the substantially flat proximal outer surface area 17 in the lapped region 16 of the cladding part of the optical fibre. The multi-layer stack is of substantially uniform thickness of about 200 nm and is substantially flat. It is in direct contact with, and forms an interface with, the flat proximal surface area of the fibre cladding and, at its outward surface 18 opposite the interface, the multi-layer stack outwardly presents from the optical fibre a substantially flat and exposed surface which extends over the interface in question.

Periodically spaced regions 200 of compaction have been photo-induced in the multi-layer stack 18 by irradiating the stack with ultraviolet radiation through a uniform phase mask to bathe the stack 18 in ultraviolet light having an intensity distribution which varied periodically (increasing and decreasing) along the stack in a direction parallel to the transmission access of the first optical waveguide 20.

The regions of compaction 200 induce local strain in the material of the stack 18 which extends into the material of the first optical waveguide 12 to which the stack is bonded to form a spatially quasi-periodic or periodic strain field 250 therein. Multiple strain-induced refractive index modulations 15 in the core part 13 of the first optical waveguide, result from this strain field and produce a periodic or quasi-periodic refractive index modulation region 14 in the core.

The core part 13 of the optical fibre includes an extended region of un-inscribed (strain-induced) refractive index modulations 14 comprising a sequence of refractive index modulations 15 each of which extends across the optical fibre core part to form an area of (modulated) refractive index. The result is to render the interface 17 between the proximal surface of the lapped cladding, and the overlying multi-layer stack 18, simultaneously in optical communication with the input end 19 of the optical fibre by reflection or scattering 22 of at least a part of an input optical signal directed into the surface plasmon generator via the input part 19 of the optical fibre 11. The reflected or scattered part 22 of the input optical signal may be employed in generating surface plasmons at the outwardly presented surface 18 of the multi-layer stack arranged upon the proximal outer surface of the fibre cladding.

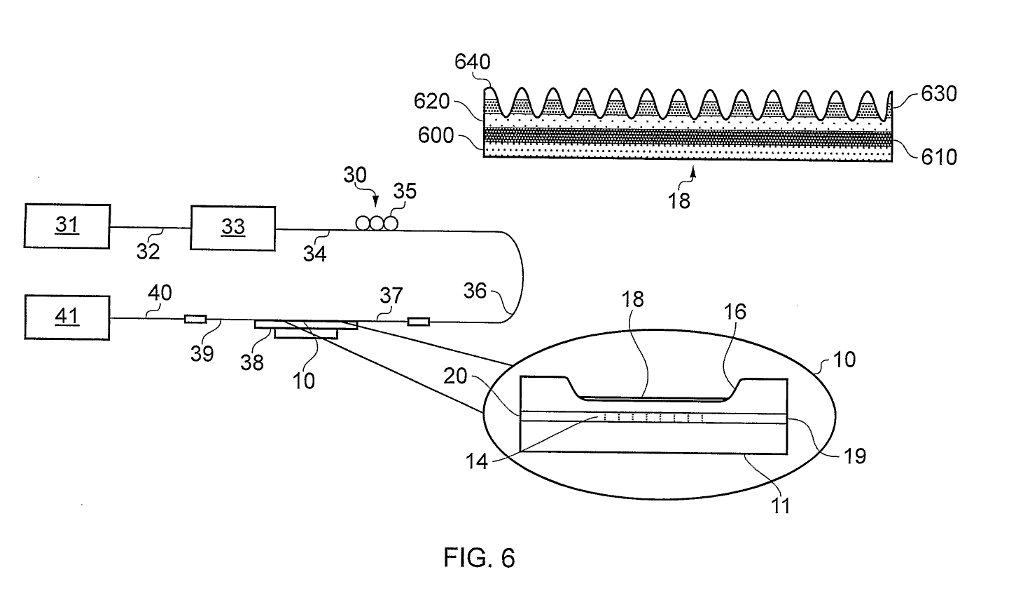

In this way, the scattering or reflection of input optical signals incident upon the refractive index modulations 15 assists the first optical waveguide to generate coupled radiative optical modes which impinge upon the multi-layer stack 18 of the surface plasmon generator 10 and thereupon resonantly generate surface plasmons when the wave vector component of the radiative modes which is parallel to the fibre axis, matches the wave vector of surface plasmons excitable at that multi-layer stack. As a result of this resonant coupling between radiative modes and surface plasmons, and in part in consequence of the optical coupling, by the refractive index modulations, between the radiative modes and the guided core modes of optical signals within the optical fibre 11, it has been found that resonant coupling of surface plasmons and radiative optical modes influences the intensity of guided core optical modes 23 transmitted through the first optical waveguide and ultimately output from the output part 20 of the surface plasmon generator. This relationship may manifest itself as a transmitted output signal intensity attenuation within the optical spectrum of output signals 23. It has been found that the wavelength at which optical signal attenuation is greatest, and/or the strength/depth of output signal attenuation, is dependent upon the refractive index of any substance present at the exposed outwardly presented surface of the multi-layer stack 18 upon which surface plasmons propagate and transversely to which (i.e. in to the adjacent substance) the electromagnetic field of these surface plasmons will extend. This property of the surface plasmon generator of FIG. 5 may be exploited in a sensor device (e.g. a biochemical sensor device) such as is illustrated in FIG. 6 as follows.

FIG. 6 graphically illustrates a sensor device comprising a broadband infra-red optical signal source 31 arranged to generate optical signals within the range 1000 nm to 2000 nm and to output such optical signals to an optical signal polariser unit 33 placed in optical communication with broadband optical signal source via a linking optical fibre 32. The polariser unit 33 is arranged to produce from input optical signals received thereby from the optical signal source 31, output optical signals of a pre-determined state of polarisation, and to output the polarised optical signals to a polarisation controller 35 with which the polariser unit 33 is in optical communication via an intermediate length of optical fibre 34. The polariser controller 35 includes a length of optical fibre mechanically twistable, or twisted, by a predetermined amount to induce a birefringence in the material of the fibre and a corresponding change in the polarisation state of the optical radiation transmitted through it.

The optical output of the polarisation controller 35 is in optical communication with the input part 19 of the surface plasmon generator 10 via an intermediate length of optical fibre 36 and a bare-fibre connector portion 37. The output part 20 of the surface plasmon generator 10 is in optical communication with the optical input of an optical spectrum analyser 41 via an intermediate bare-fibre connector 39 and length of optical fibre 40. Ends of both of the aforementioned bare-fibre connectors (37, 39) are optically coupled directly to the input and output parts of the surface plasmon generator.

In use optical signals generated by the optical signal source 31 are output thereby to the polariser unit 33 which produces therefrom a polarised optical signal for input to the polarisation controller 35 which is operable to adjust to the state of polarisation of the received polarised optical signal as required, and to subsequently output the polarised optical signal to the optical input part 19 of the surface plasmon generator 10 for use in generating surface plasmons as discussed above with reference to FIG. 5. Those parts of the polarised optical signal input to the surface plasmon generator which are transmitted through the strain-induced refractive index modulations 14 thereof are subsequently output at the output part 20 of the surface plasmon generator and are input to an optical input of the optical spectrum analyser 41 whereat the intensity and wavelength of the transmitted optical signal is measured. Subjecting the surface plasmon generator to optical signals of a wide range of differing wavelengths within the spectrum of the broadband optical signal source 31, enables a transmitted optical signal spectrum to be generated in respect of the transmitted optical signal 23 output by the surface plasmon generator. Examples of such spectra are discussed below.

The sensor device 30, illustrated in FIG. 6, also includes a sample control unit 38 in the form of a vessel containing a sample substance (e.g. a gas or an aqueous solution) within which the surface plasmon generator 10 is immersed and to which the outwardly presented surface of the multi-layer stack 18 of the surface plasmon generator is exposed.

FIG. 6 also shows an expanded view of the multi-layer stack 18. It includes a first layer of germanium 600 deposited on the lapped surface of the first optical waveguide having a uniform thickness of either 48 nm or 24 nmn. A first layer of silica 610 is deposited upon the first germanium layer having a uniform thickness of 48 nm. A second germanium layer 620 is deposited on the first silica layer having a uniform thickness of 48 nm. Both the first and second germanium layers are arranged to, or are able to, support concurrent surface plasmons on the respective surface thereof to support cross-talk therebetween to generate an enhanced surface plasmon mode. In this way, the first silica layer 610 and the first and second germanium layers it separates, collectively define a second optical waveguide coupled to the first optical waveguide 12. A second silica layer 630 of 48 nm in maximum thickness is deposited upon the second germanium layer to protect it. A layer of silver 640 is deposited upon the second silica layer to support outermost surface plasmon fields.

A periodic or quasi-periodic surface relief structure is inscribed into the outermost surface of the multi-layer stack by ultraviolet photo-inscription to produce material compaction and strain fields within the multi-layer stack as discussed above. Deposition may be carried out using conventional techniques, e.g. sputtering or the like. The deposition conditions may be controlled to provide a rough surface. This may be advantageous in broadening the surface plasmon resonance response in the spectra, i.e. so that the apparatus is operable or sensitive over a range of wavelengths.

In an alternative embodiment, all but the first germanium layer 600 of the multi-layer stack 18 may be dispensed with, or the first silica layer and the second germanium layer may be dispensed with. In such a case, the surface relief structure (and compactions) would be formed in the remaining layer(s) of material(s).

The following examples demonstrate a surface plasmon resonance fibre (SPR) sensor device fabricated via ultraviolet inscription of a grating-type surface relief structure into a multi-layered thin film deposited on the flat side of a lapped D-shaped fibre. It was found that this SPR sensor device operates in air (i.e. with air as the sensed medium/sample) with high coupling efficiency in excess of 25 dB. This device yielded a sample-index sensing resolution of approximately 10⁻⁴ in for samples having a refractive index in the range 1.0 to 1.3.

### Fabrication and Characterisation

The surface plasmon resonance (SPR) fibre sensor device such as illustrated in FIG. 5 and FIG. 6 were constructed in three stages.

Firstly, a standard single-mode silica fibre (SMF) 12 was mechanically lapped down to provide a flat lapped surface 17 within 10 mm from the core-cladding interface. Secondly, using an RF sputtering technique, such as would be readily apparent to the skilled person, a series of coatings (600, 610, 620, 630, 640 of FIG. 6) were deposited upon the flat of the lapped fibre with materials and average thicknesses of;

(600): First germanium (Ge) layer=48 nm thick,

(610): First silica (SiO₂) layer=48 nm thick,

(620): Second Ge layer=48 nm thick,

(630): Second SiO₂=48 nm thick,

(640): Final top coating of Ag=32 nm thick.

SPR devices with the same construction but with a first Ge layer adhered to the fibre having a thickness of 24 nm were also fabricated.

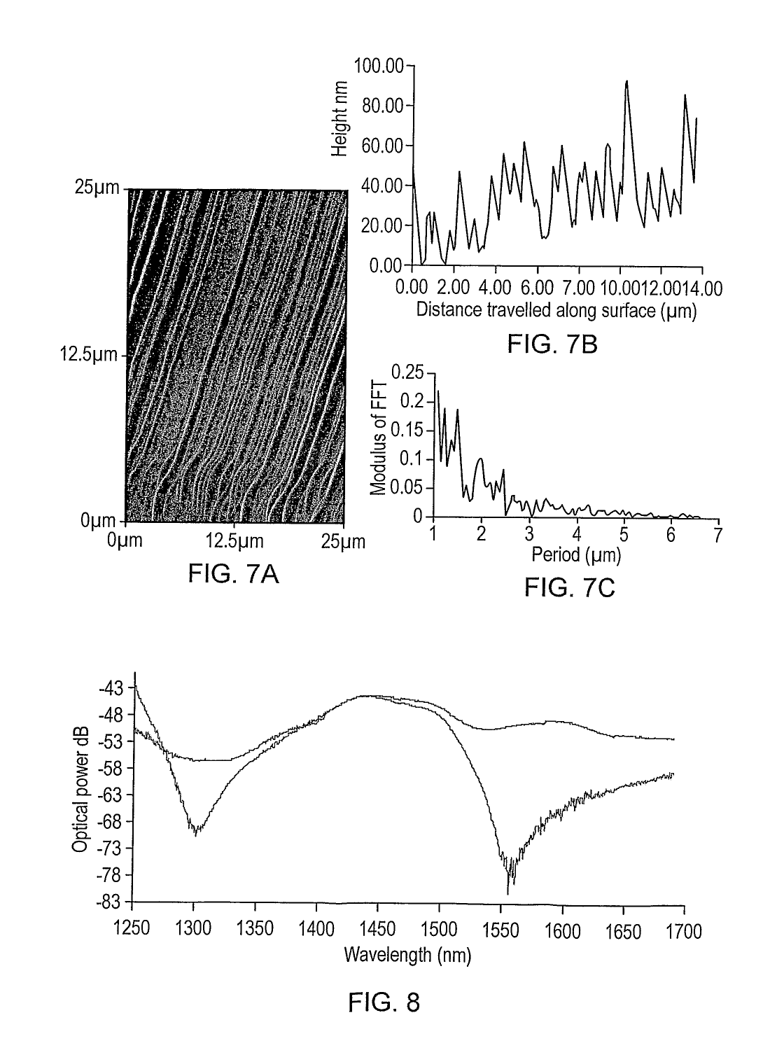

Thirdly, the coated lapped fibre was exposed to the diffracted pattern of UV light passed through a uniform phase mask. A UV laser beam was employed for this purpose and caused to scan the phase mask multiple times to effect and multiple exposures of the coated lapped fibre. This produced a surface relief structure illustrated via an atomic force microscope (AMF) image shown in FIG. 7A. This surface relief structure has approximate and predominant periods of ˜0.5 μm and ˜1 μm promoted by the UV processing described above. FIG. 7B shows a line profile across the surface of the surface relief structure, and FIG. 7C shows a fast Fourier transform of the line profile.

The phase mask had a uniform period of 1 micron and was illuminated using an Argon ion continuous wave laser operating at a wavelength of 244 nm and an output power of 100 mW. The output UV beam was passed through an aperture to improve the beam profile (minimise diffraction pattern) and then through a plano-convex lens having a focal point coincident with the phase mask and multi-stack layer to be irradiated. The UV light was passed through the phase mask to produce a diffraction pattern of UV light which impinged upon the multi-stack layer of the surface plasmon generator device. The focussed UV light was scanned over the phase mask and multi-stack layer, which remained static, at a speed of 0.1 mm/sec. Seven such scans were performed.

The fibre devices were characterised by measuring changes in the polarisation properties of the light caused by passage through the surface plasmon generator 11.

Light from a broadband light source, is passed through a polariser, and a polarisation controller before illumination of the sample, with the transmission spectra being monitored using an optical spectrum analyser (accuracy of 0.005 nm), see FIG. 6.

For different states of linear polarisation (e.g. P-states or S-states) of radiation input to the devices, high extinction SPR coupling modes were observed. Light polarised in a P-state (e.g. input field vector perpendicular to lapped fibre surface) was found to produce the strongest couplings in general.

For an SPR device having a first Ge layer (600) thickness of 48 nm, a resonance was observed at a wavelength of optical radiation of 1300 nm and had a maximum observed coupling of ˜36 dB. A resonance was also observed at an optical radiation wavelength of 1560 nm with a maximum observed coupling of ˜45 dB. The surrounding medium sensed by the device was air in each case. FIG. 8 illustrates the transmission spectra of the device in question illuminated by optical radiation having two different linear polarisation states.

### Refractive Index Sensitivity

Refractive index sensitivity measurements the SPR devices were performed by placing the device 11 in a V-groove holder and immersing it in certified refractive index (CRI) liquids (supplied by Cargille laboratories Inc.) which have a quoted accuracy of ±0.0002.

The device and V-groove were carefully cleaned, washed in ethanol, then in deionised water, and finally dried before the immersion of the SPR device into the next CRI liquid.

The V-groove was made in an aluminium plate, machined flat to minimise bending of the fibre. The plate was placed on an optical table, which acted as a heat sink to maintain a constant temperature.

The spectral sensitivity of the SPR fibre devices to changes in the refractive index of the surrounding medium in which it was immersed, was measured before and after UV inscription of the surface relief structure described above.

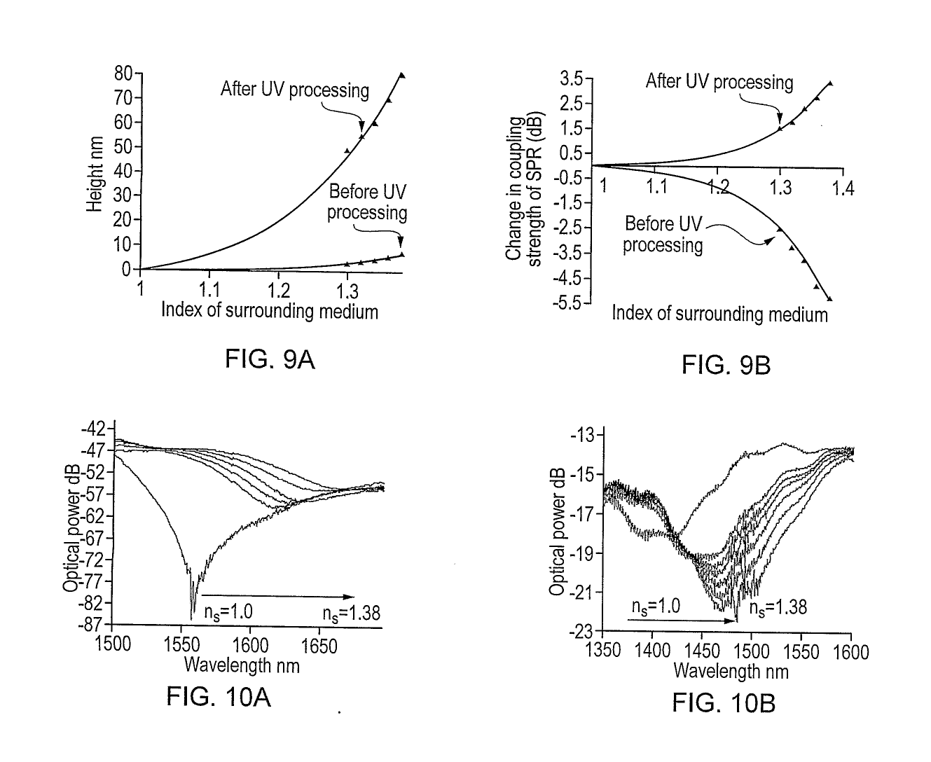

FIGS. 9A and 9B, relating to an SPR fibre device 11 with a first Ge layer (600) of 24 nm thickness, show a dramatic change in the spectral behaviour of the SPR fibre device as a result of the UV processing step, and the effects it has on the device.

FIG. 9A shows the shift in the spectral (wavelength) position of the spectral resonance displayed by the device, while FIG. 9B shows the variation of the coupling strength (depth) of the spectral resonance. Varying the thickness of the first germanium layer (600) adhered to the flat of the D shaped fibre also changes the spectral performance of this type of SPR fibre device.

Examples of the spectral responses of the devices as a function of the surrounding medium's refractive index (nₛ) along with varying the thickness of the first layer of germanium are shown in FIGS. 10A and 10B. Note that the noise present in the transmission spectra at the maximum coupling strength of the SPR fibre device (i.e. spectral resonance “dip”) at 1550 nm, is an artefact of Optical Spectrum Analyser (OSA) due to the operating conditions of the interrogation scheme; e.g. illumination light levels, resolution and sensitivity settings used for the OSA. In FIGS. 10A and 10B, the transmission spectra of SPR fibre device as a function of surrounding medium's refractive index (nₛ) are shown as follows: FIG. 10A, a thickness of 48 nm for the first layer (600) of germanium; FIG. 10B, a thickness of 24 nm for the first layer (600) of germanium.

The index sensitivity in the aqueous index regime (index exceeding 1.3) of the SPR fibre device (48 nm thickness of first layer of germanium) is approximately dλ/dnₛ=911 nm, assuming a wavelength resolution of 0.1 nm leading to an index resolution of about 1.0×10⁻⁴. A most interesting response of the SPR device is found when coupling in air and the dramatic changes which occur when the device is submerged into index solution of 1.3.

It was found that the wavelength shift (dλ, in nm) as a function of the refractive index of the surrounding medium is approximately dλ=1.3066(nₛ)^{14.147}, where nₛ is the refractive index of the surrounding medium. Using this expression, an estimate of the spectral sensitivity of the SPR fibre device can be given for low refractive indices from 1 to 1.1; namely, dλ/dnₛ=37 nm, leading to an index resolution of ˜2.6×10⁻³ (using a spectral interrogation technique with a resolution of 0.1 nm) with an overall wavelength shift in the spectral position of the resonance of ˜55 nm applicable to samples ranging from air to samples having a refractive index of 1.300.

Comparing the devices fabricated with a first Ge layer 48 nm thick, to those fabricated with a first Ge layer 24 nm thick, it was found that this change in Ge thickness dramatically changed the spectral characteristics of the SPR fibre device producing an index sensitivity of dλ/dnₛ˜447 nm leading to an index resolution of ˜2.1×10⁻⁴ (assuming the same resolution).

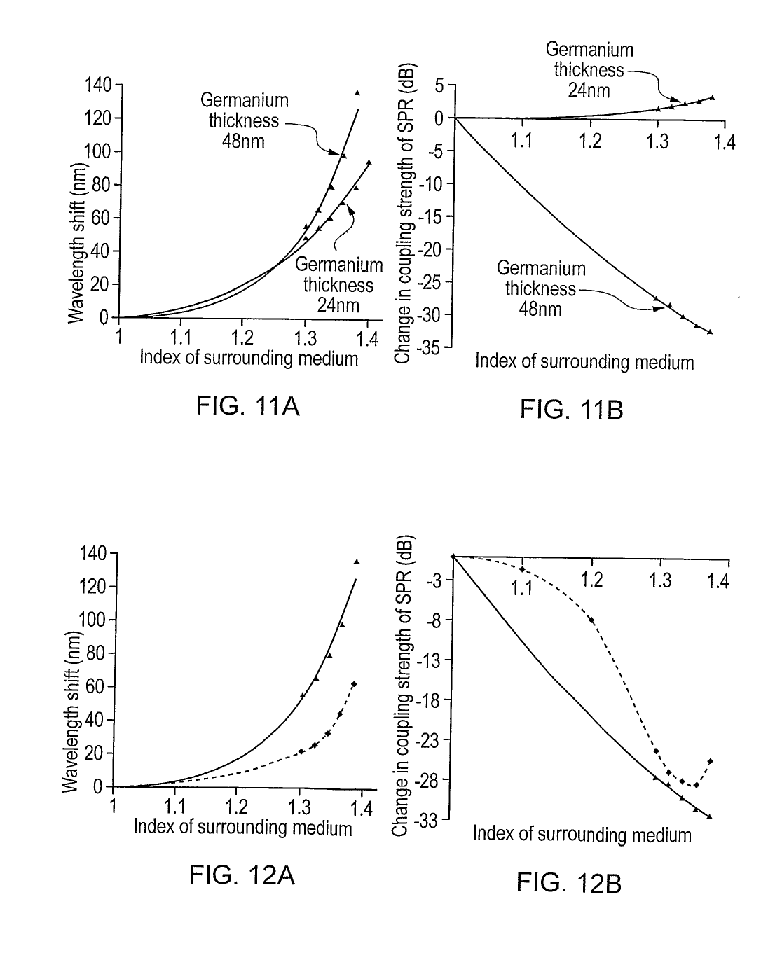

It was found with the SPR fibre device having a first Ge layer of 24 nm thickness the wavelength shift (dλ, in nm) as a function of surrounding index (nₛ) is dλ=4.7(nₛ)^{9.0209}, again, giving estimate for a sample index range from 1 to 1.1 of dλ/dnₛ˜64 nm, and leading to an index resolution of ˜1.5×10⁻³. FIGS. 11A and 11B illustrate this graphically.

FIGS. 11A and 11B show the spectral behaviour of the SPR fibre device with different thickness of the first layer of germanium adhered to the flat of the D shaped fibre as a function of surrounding index. FIG. 11A illustrates the wavelength shift of the position of the spectral resonance, and FIG. 11B illustrates the variation of coupling strength (depth) of the spectral resonance.

Considering the optical coupling strength spectral variation of the SPR with 48 nm thick first germanium layer, an index resolution of ˜9×10⁻⁵ is possible with a 0.1 dB detection scheme.

The SPR (48 nm thickness of first germanium layer) fibre device was compared to the theoretical SPR spectral response of the purely D-shaped fibre coated with only a layer of germanium of the same thickness. A model was produced for these SPR fibre devices by firstly calculating the scattering angles associated with the various transverse mode (TE/TM) propagation constants generated by a D-shape fibre with a germanium coating. The leaky TE_{V}/TM_{V} mode propagation constants were calculated using the dispersion relationships derived in “Optical Fibre Waveguide Analysis”; C. Tsao, Oxford University Press, ISBN-10: 0198563442.

The scattering angle (α) is calculated from the propagation constants of the cladding modes having indices (n_{β}) by the relationship given by the ray approach

cos α=n_{β}/nᵣ₁,

where nᵣ₁ is the refractive index of the cladding, this angle being relative to the fibre axis. These angles are used to give an associated incident angle (φ) of each cladding mode onto the metal/dielectric interface and thus the cladding mode wave-number projection onto that interface. Surface plasmons are generated when this wave-number projection matches the dispersion relation of the plasmons, thus:

$$\frac{2 π}{λ} \sqrt{( \frac{{ɛ ( λ )}_{m} \cdot {n ( λ )}_{s}^{2}}{{ɛ ( λ )}_{m} + {n ( λ )}_{s}^{2}} )} = \frac{2 π \cdot {n}_{cl}}{λ} sin ( ϕ )$$

The theoretical spectral transmission response of the SPR fibre device is obtained by calculating the reflected intensity of the fibre device at various wavelengths. The quantitative description of the minimum of the reflected intensity R for a SPR can be given by Fresnel's equations for a three layered system. The reflectivity R for P-polarised light, is given in H. Rather: “Surface plasmons on smooth and rough surfaces and on gratings”; Springer Verlag, ISBN 3-540-17363-3, for a “smooth surface”. The results are shown in FIGS. 12A and 12B.

FIG. 12A shows the spectral sensitivity of SPR device as a function of surrounding medium's refractive index. FIG. 12B shows the optical coupling strength as a function of surrounding index. Experimental data for the multi-coated fibre are shown by the solid lines, while theoretical data for a germanium coated fibre device are shown by the dashed lines.

Using the above procedure we obtain dλ=(nₛ)^{12.281}. Using this expression, the spectral sensitivity of the SPR fibre device can be given for low refractive indices from 1 to 1.1, as dλ/dnₛ˜22 nm with an overall wavelength shift of ˜21 nm from air samples to samples (e.g. solution) having an index of 1.300.

Comparing the two results shows that additional coatings have enhanced the spectral sensitivity to index, FIGS. 12A and 12B, and with some increase in the variation of the optical coupling strength. This suggests that this multilayered structure sandwiched between glass and air is a coupled waveguide-surface plasmon resonance (CWSPR) structure. Furthermore, the CWSPR sensor also provides a sharp dip in the transmission spectrum in air, which therefore enhances measurement precision.

These examples demonstrate a SPR fibre sensor device utilising multilayered thin film deposited on the flat side of a lapped D-shaped fibre which as a surface relief grating inscribed by ultra-violet light. It was found that this SPR device operates in air with high coupling efficiency in excess of 25 dB. This device yielded an index resolution of ˜10⁻⁴ for sensed samples having a refractive index value in the range from 1.0 to 1.3 whilst still giving a high spectral index sensitive of dλ/dnₛ˜911 nm in the aqueous index regime.

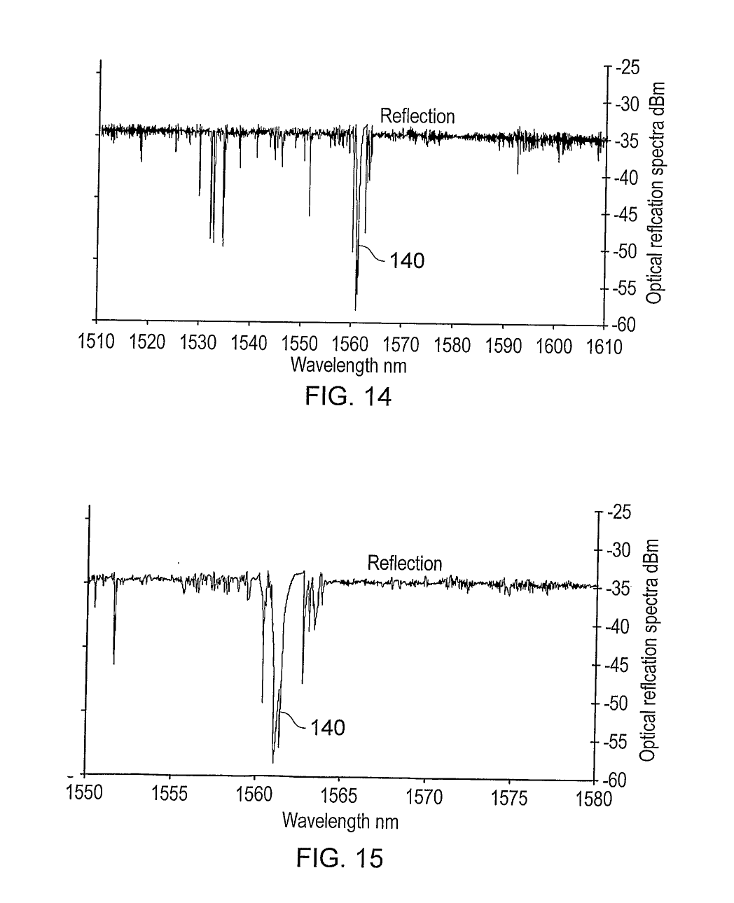

FIG. 14 graphically illustrates the reflection spectrum of the surface plasmon generator of FIG. 5, when the surface plasmon generator is surrounded only by air. The reflection spectrum is in respect of linearly polarised input optical radiation. FIG. 15 graphically illustrates an expanded view of part of FIG. 14. This shows a spectral resonance 140 identifying an SPR coupling seen as a sharp spectral dip in an otherwise relatively high back reflection signal. Back reflected signals are believed to be produced by strain-induced refractive index variations in the optical waveguide through which input light is guided.

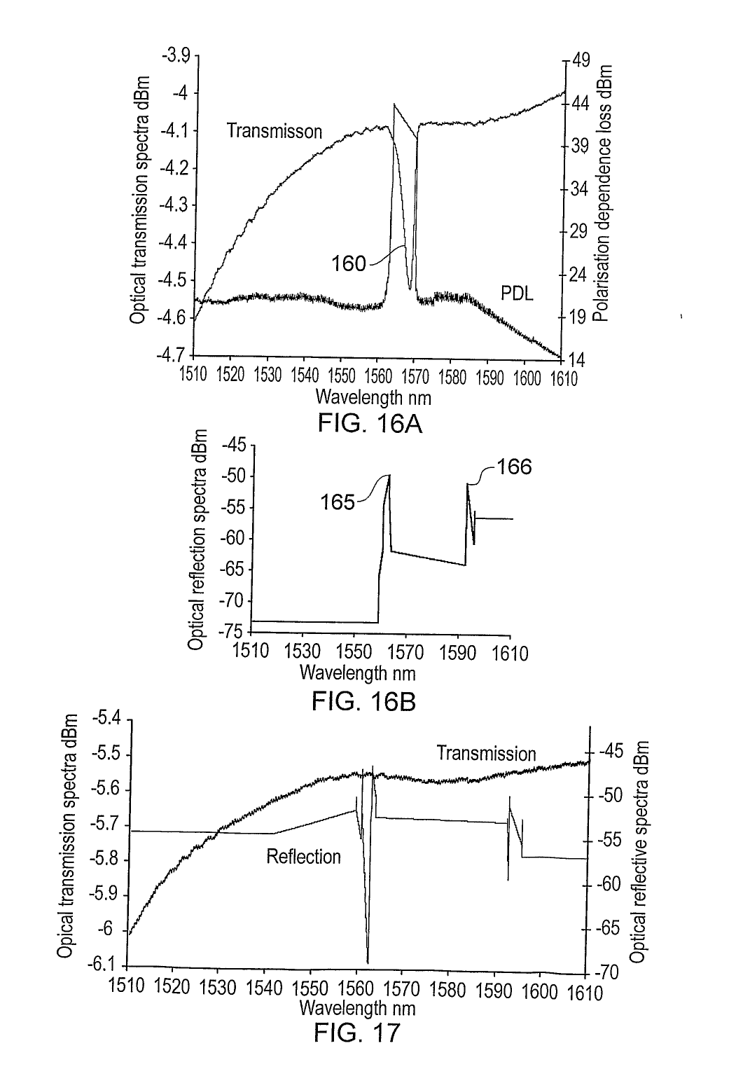

FIGS. 16A and 16B graphically illustrate the transmission spectrum (FIG. 16A) and the reflection spectrum (FIG. 16B) of the surface plasmon sensor device with which FIGS. 14 and 15 are concerned, but in respect of a lower input optical signal intensity and a different state of linear polarisation. A polarisation-dependent loss spectrum (PDL) is also shown in FIG. 16A, this being defined as the magnitude of the vector sum of the losses to each of the Stokes vectors of input optical radiation. The transmission spectrum shows a resonance structure 160 identifying an SPR coupling causing light to be coupled out of the main waveguide of the surface plasmon generator to generate a surface plasmon at the multi-layer stack 18 of the device. The peak in PDL illustrates this loss of optical energy from the guided input light. FIG. 16B shows clear reflection peaks (165, 166). These reflected signals are believed to be produced by strain-induced refractive index variations in the optical waveguide through which input light is guided.

FIG. 17 graphically illustrates a reflection spectrum and a transmission spectrum of the surface plasmon sensor device with which FIG. 16 is concerned, but in respect of a different state of linear polarisation of input optical radiation. The reflected signal is higher and a clear reflection attenuation resonance is observed at wavelengths associated with an SPR coupling indicating a stronger coupling to surface plasmons. Clear reflection peaks are seen.

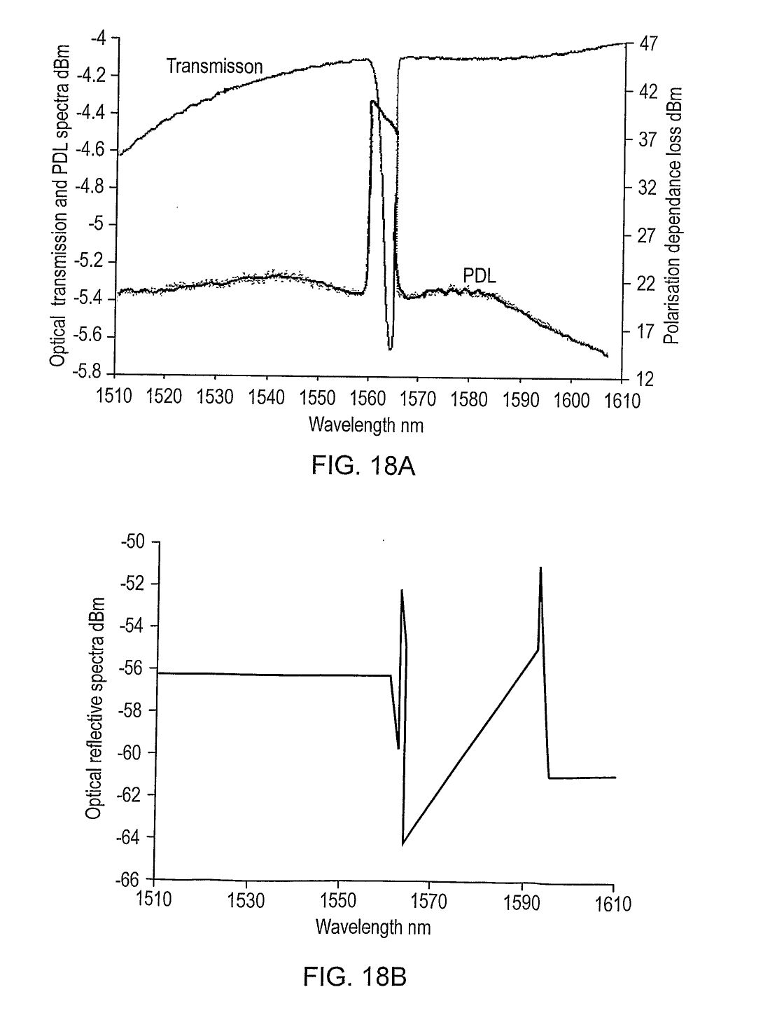

FIGS. 18A and 18B graphically illustrate a reflection spectrum (FIG. 18B) and a transmission spectrum and PDL spectrum (FIG. 18A) of the surface plasmon sensor device with which FIGS. 16 and 17 are concerned, but in respect of a different state of linear polarisation of input optical radiation. Similar spectral features are seen in the reflected light signal.

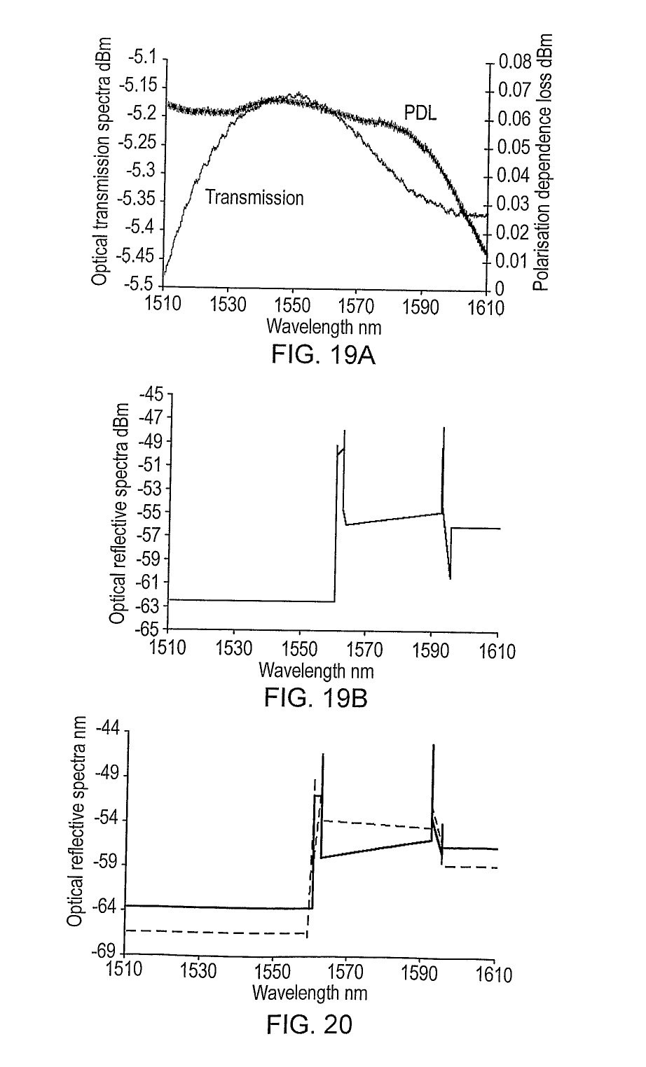

FIGS. 19A and 19B graphically illustrate a reflection spectrum (FIG. 19B) and a transmission spectrum and PDL spectrum (FIG. 19A) of the surface plasmon sensor device with which FIGS. 16, 17, 18A and 18B are concerned, but in respect of a different state of linear polarisation of input optical radiation. For the state of linear polarisation employed in this example, no SPR resonance is observed, yet the reflection peaks exist in the reflection spectrum indicating the existence of a reflective structure in the fibre through which the optical radiation passed which is resonantly effective at specific wavelengths.

FIG. 20 graphically illustrates a reflection spectrum of the surface plasmon generator with which FIGS. 16 to 19 are concerned, and in respect of two different states of linear polarisation (different position angle of electric field vector of input radiation) of input optical radiation. Changes in polarisation state produce changes in reflectance of the reflecting structure in the guiding core of the surface plasmon generator, but do not significantly change the spectral position of reflection resonance peaks.

The presence of this spectral feature in the reflected spectrum, suggests that there is a periodic index variation 14 in the core 13 of the fibre 12 of the surface plasmon generator 11, which is able to produce a coupling of input optical radiation to a counter-propagating core mode(s).

The reflection resonances are spectrally broad, suggesting that period of the refractive index modulation 14 of the silica material of the core 13 of the optical fibre 12, varies along or within the core, and that it is a relatively weak refractive index perturbation. This is consistent with the Fourier transform of the line profile of the photo-induced surface relief structure of the surface plasmon generator illustrated in FIG. 7(c). The periodic strain field 250 may be small and have a relatively weak interaction with the core. Furthermore, this spectral broadness may be in part a result of spatial variation in the strain field, due to the variation in the material thickness and compositions from place to place thus producing variations in the interaction of parts of the multi-layer stack with the UV radiation when undergoing UV processing as discussed above. This may produce variations in the periodicity on the surface relief structure (FIG. 7(a)) and the distribution of material compaction in the multi-layer stack, thus varying the strain field.

The spectral reflection features are polarisation dependent indicating that refractive index modulation 15 across the core 13 of the waveguide 12 of the device, is not radially symmetric, as one would expect of such a grating-like structure.

A commercially available “ExFo Kit” device was employed to produce the spectra of FIGS. 14 to 20, with differing polarisation states of the optical radiation launched into the surface plasmon generator by the Kit. The “ExFo Kit” contains a tuneable laser producing light polarised as required in one of four states: linearly (horizontal), linearly (vertical), right circular, and left circular. The operating wavelength range was from ˜1500 nm to ˜1600 nm. One output port of the Kit illuminated the surface plasmon generator with radiation 21 at the optical input end 19 thereof, and the optical output radiation 23 of the surface plasmon generator was input to the Kit to be monitored/measured.

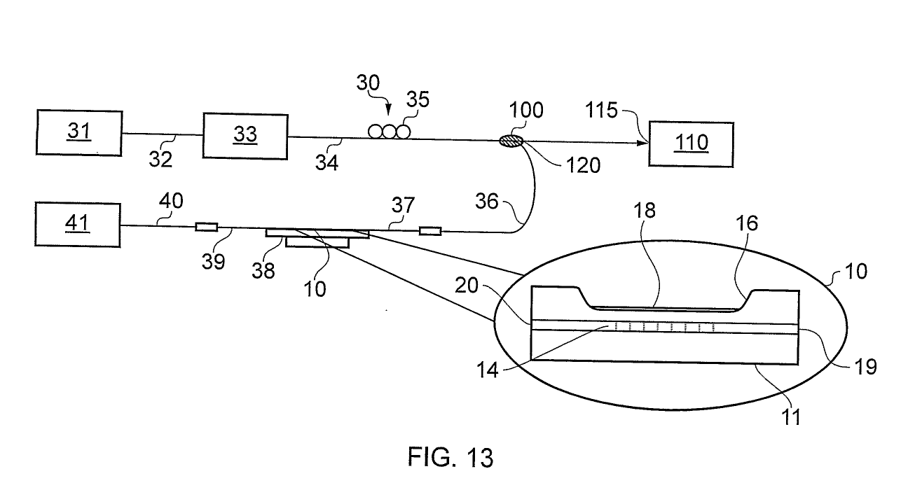

The dependency of these SPR devices upon the state of polarisation of the illumination radiation was investigated using the apparatus schematically illustrated in FIG. 13. This comprises the apparatus of FIG. 6 further including a polarisation-maintaining coupler 100 coupled to the optical line 36 between the polarisation controller 35 and the lapped fibre 10, and arranged to sample a portion of light propagating along the optical line from the optical signal source 31 to the lapped fibre. The sampled, polarised radiation is directed a polarimeter 110 having an optical input 115 in optical communication (via a fibre) with an optical output 120 of the polarisation-maintaining coupler 100. In this way, the polarimeter is arranged to measure the state of polarisation of the radiation illuminating the lapped fibre 10. This may include measuring the polarisation angle (e.g. azimuth) of linearly or elliptically polarised light produced by the polariser and polarisation controller (33, 35).

Variants of, and alternatives to, the examples of the invention described, such as would be readily apparent to the skilled person, are encompassed within the scope of the present invention, and the examples given above e.g. with reference to the accompanying drawings, are not intended to be limiting.

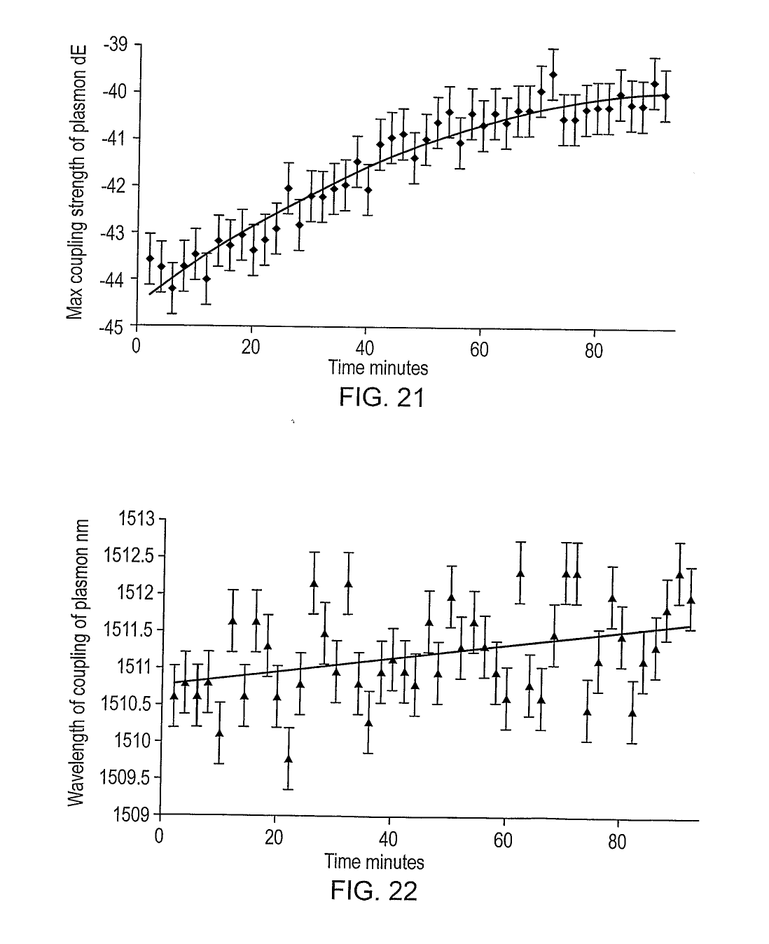

FIGS. 21-24 are graphical representations of results obtained from an experimental in which a sensor similar to that discussed with reference to FIG. 6 above (and in which the active layer comprised a silver-silica-germanium multilayer) was exposed to ethanol vapour. The ethanol was heated during the course of the experiment producing ethanol vapour. The ethanol vapour mixes with the air causes changes in the refractive index of the atmosphere in the gas chamber.

FIGS. 21-24 demonstrate that such a change is detectable using the apparatus of the invention.

During the experiment room temperature was monitored at 22.8±0.3° C. and output spectra from the sensor were taken at regular intervals.

FIG. 21 is a graph showing the maximum coupling strength of the plasmons taken from the resonance detected in each output spectra. A change in optical power of 4 dB was observed through the course of the experiment. The calculated error on the maximum coupling strength on the other hand was only ±0.55 dB.

Similarly, FIG. 22 is a graph showing the maximum coupling wavelength of the plasmons taken from the resonance detected in each output spectra. A change in wavelength of ˜2 nm was observed through the course of the experiment, whereas the calculated error on the maximum coupling strength was ±0.42 nm.

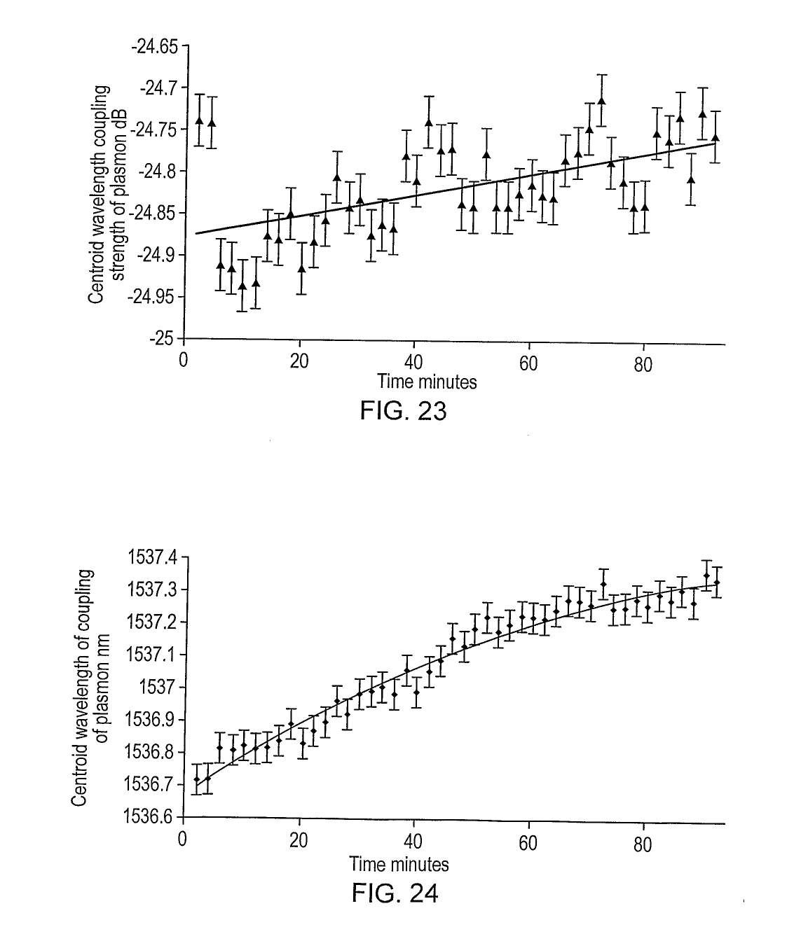

Using the same output spectra, FIGS. 23 and 24 are graphs showing the maximum coupling strength and wavelength respectively that are based on centroid values. Using this technique the changes in coupling strength and wavelength are even more marked.

1-42. (canceled)

43. A method of producing a surface plasmon generator, the method comprising:
providing an optical waveguide;
providing a layer of material(s) optically coupled and adhered to an outer surface of the optical waveguide; and
irradiating the outermost surface of the layer of material(s) to:
photo-induce one or more regions of material compaction within the layer of material(s), and
generate in the optical waveguide a strain field corresponding to the regions of material compaction, thereby creating one or more strain-induced refractive index modulations in the optical waveguide adjacent to the layer of material(s);
wherein the layer of material(s) is arranged to support upon a surface thereof a surface plasmon generated by optical radiation input to the optical waveguide.

44. The method according to claim 43, wherein the optical waveguide is an optical fibre having a core part and a cladding part adjacent to the core part, and wherein the one or more strain-induced refractive index modulations extend across the core part and are non-radially symmetric relative to an optical axis of the core part.

45. The method according to claim 44 including lapping the cladding part to form a lapped region of the optical fibre having a D-shaped cross-sectional profile, wherein the layer of material(s) is provided on the cladding part in the lapped region.

46. The method according to claim 43, wherein irradiating the outermost surface of the layer of material(s) inscribes upon the surface thereof an undulating surface relief profile.

47. The method according to claim 43, wherein providing a layer of material(s) includes depositing the layer of material(s) on the optical waveguide.

48. The method according to claim 47, wherein depositing the layer of material(s) includes depositing a layer of metal as the outermost surface of the layer of material(s).

49. The method according to claim 43, wherein providing the layer of material(s) comprises optically coupling and adhering a second optical waveguide to an outer surface of the optical waveguide, the second optical waveguide including an optically transparent material separating two layers each formed from a material arranged to support upon a respective surface thereof a surface plasmon generated by optical radiation input to the first optical waveguide.

50. The method according to claim 49, wherein optically coupling and adhering the second optical waveguide includes successively depositing a first layer of the two layers, the optically transparent material, and a second layer of the two layers to form on the first optical waveguide a stack of materials defining the second optical waveguide.

51. The method according to claim 50, wherein providing the layer of material(s) further includes successively depositing on the second optical waveguide a further optically transparent material, and a layer of metal on the further optically transparent material thereby to extend the stack.

52. A surface plasmon generator having:
an optical waveguide arranged to guide optical radiation input thereto; and
a layer of material(s) adhered to an outer surface of the optical waveguide and optically coupled thereto,
wherein the layer has photo-induced regions of material compaction therein and is arranged to support upon a surface thereof a surface plasmon generated by optical radiation input to the main optical waveguide, and
wherein the optical waveguide has one or more strain-induced refractive index modulations therein adjacent to the layer of material(s), the one or more refractive index modulations corresponding to a strain field generated in the optical waveguide by the regions of material compaction in the layer of material(s).

53. The surface plasmon generator according to claim 52, wherein the one or more refractive index modulations extend in a direction transverse to an optical transmission axis of the optical waveguide.

54. The surface plasmon generator according to claim 52, wherein the optical waveguide is an optical fibre having a core part and a cladding part adjacent to the core part, and wherein the one or more strain-induced refractive index modulations extend across the core part and are non-radially symmetric relative to an optical axis of the core part.

55. The surface plasmon generator according to claim 54, wherein the cladding part includes a lapped region in which the optical fibre has a D-shaped cross-sectional profile, and wherein the layer of material(s) is provided on the cladding part in the lapped region.

56. The surface plasmon generator according to claim 52, wherein the outermost surface of the layer of material(s) has an undulating surface relief profile.

57. The surface plasmon generator according to claim 52, wherein the outermost surface of the layer of material(s) is a layer of metal.

58. The surface plasmon generator according to claim 57, wherein the layer of metal is formed as a plurality of spatially separated metal regions.

59. The surface plasmon generator according to claim 52, wherein the layer of material(s) comprises a second optical waveguide optically coupled and adhered to an outer surface of the optical waveguide, the second optical waveguide including an optically transparent material separating two layers each formed from a material arranged to support upon a respective surface thereof a surface plasmon generated by optical radiation input to the first optical waveguide.

60. The surface plasmon generator according to claim 52, wherein the layer of material(s) further includes a further optically transparent material on the second optical waveguide, and a layer of metal on the further optically transparent material.

61. A sensor comprising:
a surface plasmon generator having:
an optical waveguide arranged to guide optical radiation input thereto; and
a layer of material(s) adhered to an outer surface of the optical waveguide and optically coupled thereto,
wherein the layer has photo-induced regions of material compaction therein and is arranged to support upon a surface thereof a surface plasmon generated by optical radiation input to the main optical waveguide, and
wherein the optical waveguide has one or more strain-induced refractive index modulations therein adjacent to the layer of material(s), the one or more refractive index modulations corresponding to a strain field generated in the optical waveguide by the regions of material compaction in the layer of material(s),
an optical radiation source in optical communication with the optical waveguide to input optical radiation thereto, and
an optical radiation detector arranged to detect optical radiation output from the surface plasmon generator,
wherein the layer of material(s) adhered to the outer surface of the optical waveguide defines a sensing area for receiving a sample to be sensed.

62. The sensor according to claim 61, including a polarisation control means in optical communication with the optical radiation source and the surface plasmon generator, the polarisation control means being arranged to control the state of polarisation of optical radiation from the optical radiation source for input to the surface plasmon generator.
